(19) United States
(12) Patent Application Publication
(10) Pub. No.: US 2004/0095105 A1
(43) Pub. Date: May 20, 2004

(54) Power supply device and liquid crystal display device using the same

(75) Inventor: Kenichi Nakata, Kyoto-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: ROHM CO., LTD.

(21) Appl. No.: 10/706,931

(22) Filed: Nov. 14, 2003

(30) Foreign Application Priority Data
Nov. 18, 2002 (JP) 2002-333550

(51) Int. Cl. G05F 1/40

(52) U.S. Cl. 323/280

(57) ABSTRACT

A power supply device relating to the invention comprises a switching element connected between two different potentials, an output smoothing section for smoothing a voltage outputted from a terminal of the switching element and produce an output voltage provided for a load, a driver section for driving and controlling the switching element, and an output current sensing section for monitoring current flowing through the load, the output current sensing section provided in a stage after the output smoothing section. The power supply device is configured in such a way that, when a desired output voltage is produced from an input voltage, the switching element is driven and controlled by the driver section by incorporating a monitored result obtained by the output current sensing section. According to this configuration, it is possible to produce a stable output voltage even if there are abrupt changes of load.

### BACKGROUND OF THE INVENTION

1. Field of the Invention

The present invention relates to a power supply device in general requiring a faster response to a fluctuating load and generating a desired output voltage from an input voltage for such particular applications as a power supply for a liquid crystal display monitor and a large liquid crystal display TV, and as an on-board power supply.

2. Description of the Prior Art

A typical conventional DC/DC converter is configured in such a way that it has an error amplifier for amplifying a difference voltage between a reference voltage and a monitored voltage that changes in accordance with an output voltage, and that an output transistor is controlled and driven by using a voltage outputted from the error amplifier.

By using such a DC/DC converter configured as described above, a stable output voltage is certainly produced even if a load fluctuates to some extent, because the output voltage is fed back so as to make the output voltage equal to a set value.

However, in the DC/DC converter as configured above, when there is an abrupt change of load, an output signal from the error amplifier is unable to follow the change and the output voltage may fluctuate to a large extent (refer to FIG. 3), because the error amplifier is configured and used as an integrator in such a DC/DC converter having a configuration as described above. Although the output voltage is controlled so as not to fluctuate much if an output capacitor having a large capacitance is used, the disadvantages are a cost and an area for installation because such output capacitors are costly in such a configuration.

Among conventional power supply devices, there is such a power supply device in which, by monitoring an output voltage and a switching current flowing through an output transistor, and also by monitoring charge and discharge currents of an output capacitor, the output transistor is driven and controlled in accordance with results obtained through the monitoring process (refer to Japanese Patent Application Laid-Open No. 2001-112250 and Japanese Patent Application Laid-Open No. 2000-299981). It is obvious that it is possible to keep the change of output voltage within a certain level, because the output transistor can be directly driven and controlled according to the results obtained by monitoring the switching current and the charge and discharge currents even if the error amplifier is unable to follow the fluctuations of load in such a power supply device configured as above. However, items to be monitored are limited to the switching current flowing through the output transistor and the charge and discharge currents of the output capacitor. As a result, it may be possible that the output voltage changes to no small extent as in the above-mentioned case, because the output transistor cannot be driven and controlled so as to follow the fluctuations of load, because an output current actually flowing through the load is not monitored.

Particularly, in a liquid crystal display device comprising a liquid crystal display (hereinafter an LCD), when power supplied to a data signal generating section that generates data signals to the LCD (voltage signals applied to source lines of pixel transistors that form the LCD) becomes unstable, data are written to the pixel transistors insufficiently. Consequently, because this may cause deterioration in image quality such as a low contrast and a brightness decline, a faster responsivity to the fluctuations of load is demanded for a power supply device for use in such an application.

### SUMMARY OF THE INVENTION

An object of the present invention is, in light of the above-mentioned problems, to provide at a lower cost, a power supply device capable of producing a stable output voltage even if there are abrupt fluctuations of load. Another object of the present invention is to provide a liquid crystal display device capable of displaying images in superior quality with reduced problems such as a low contrast and a contrast decline by reducing a possibility of insufficient data writing to pixel transistors.

To achieve the above object, according to one aspect of the present invention, a power supply device relating to the invention comprises a switching element connected between two different potentials, an output smoothing section for smoothing a voltage outputted from a terminal of the switching element and produce an output voltage provided for a load, a driver section for driving and controlling the switching element, and an output current sensing section for monitoring current flowing through the load, the output current sensing section provided in a stage after the output smoothing section. The power supply device is configured in such a way that, when a desired output voltage is produced from an input voltage, the switching element is driven and controlled by the driver section by incorporating a monitored result obtained by the output current sensing section.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a circuit diagram showing key portions of a DC/DC converter embodying the present invention;

FIG. 2 is a schematic diagram showing an output control operation of a DC/DC converter embodying the present invention; and

FIG. 3 is a schematic diagram showing an output control operation of a conventional DC/DC converter.

### DESCRIPTION OF THE PREFERRED EMBODIMENTS

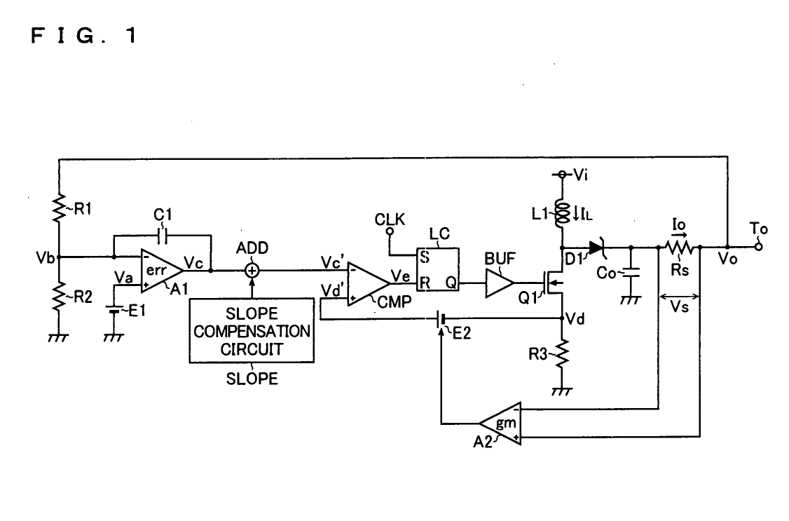

FIG. 1 is a circuit diagram of a DC/DC converter embodying the present invention. As shown in this illustration, the DC/DC converter embodying the present invention has an N-channel field-effect transistor Q1, as a switching element, connected between two points having different potentials (between an input voltage Vi and ground potential), and is a booster-type DC/DC converter for obtaining a desired output voltage Vo from a drain of the transistor Q1. The transistor Q1 is controlled in a peak current mode control system by which the control is performed based on an inductor current IL flowing through an output inductor L1.

The drain of the transistor Q1 is connected to a power line (an input voltage Vi) through the output inductor L1 of several μH and, at the same time, also connected to an anode of a reverse-current preventing diode D1, i.e., a Schottky diode. A cathode of the reverse-current preventing diode D1 is connected to an output terminal To through a sensing resistor Rs having a resistance of 0.1 ohms or less and, at the same time, connected to ground through an output capacitor Co having a capacitance of about 10 μF.

The output terminal To is connected to ground through resistors R1 and R2. A node between the resistors R1 and R2 is connected to an inverting input terminal (−) of an error amplifier A1. A non-inverting input terminal (+) is connected to a positive terminal of a DC voltage source E1. A negative terminal of the DC voltage source E1 is connected to ground. An output terminal of the error amplifier A1 is connected to one input terminal of an adder ADD, and also connected to the inverting input terminal (−) of its own through a phase compensation capacitor C1. Another input terminal of the adder ADD is connected to an output terminal of a slope compensation circuit SLOPE. An output terminal of the adder ADD is connected to an inverting terminal (−) of a comparator CMP.

The source of the transistor Q1 is connected to ground through a resistor R3 and, at the same time, connected to a non-inverting terminal (+) of the comparator CMP through a variable DC voltage E2. An output terminal of the comparator CMP is connected to a reset terminal R of a reset-priority-type RS latch LC. A set terminal (S) is connected to a clock terminal through which a clock signal CLK having a frequency of 200 KHz to 1 MHz is fed. An output terminal (Q) of the RS latch LC is connected to a gate of the transistor Q1 through a buffer BUF.

One side (an input side) of the sensing resistor Rs is connected to an inverting terminal (−) of a gm amplifier A2. Another side (an output side) of the sensing resistor Rs is connected to a non-inverting terminal (+) of the gm amplifier A2. An output terminal of the gm amplifier A2 is connected to a voltage control terminal of the variable DC voltage source E2. To be specific, voltage that the variable DC voltage source E2 produces is controlled so as to vary in accordance with a voltage Vs appearing across the sensing resistor Rs and varying according to an output current Io.

Now, the functions of the DC/DC converter configured as above will be described. The error amplifier A1 produces an error voltage Vc by amplifying a voltage difference between a reference voltage Va (the voltage produced by the DC voltage source E1) applied to the non-inverting terminal (+) thereof and a first monitored voltage Vb (a divided voltage of the output voltage Vo) applied to the inverting terminal (−) thereof. Consequently, the more the output voltage Vo drops from a target voltage, the higher the level of the error voltage Vc becomes.

The comparator CMP produces a reset signal Ve to be fed to the RS latch LC by comparing between an modified error voltage Vc′ (a sum of the error voltage Vc and a slope compensation voltage) to be applied to the inverting input terminal (−) thereof and a modified second monitored voltage Vd′ (a sum of a second monitored voltage Vd that appears across the resistor R3 and changes according to the inductor current IL and a voltage produced by the variable DC voltage source E2) to be applied to the non-inverting input terminal (+) thereof. As a result, the reset signal Ve switches to a low level when the modified error voltage Vc′ inputted to one of the terminals is higher by a predetermined threshold value than the modified second monitored voltage Vd′, or otherwise, switches to a high level.

While the above-mentioned reset signal Ve is maintained at the low level, an on-off status of the transistor Q1 is controlled so that the transistor Q1 is switched according to the clock signal CLK to be applied to the set terminal (S) of the RS latch LS. By contrast, while the reset signal Ve is maintained at the high level, the transistor Q1 is kept in an off-state and a switching operation thereof is stopped regardless of the clock signal CLK.

In this way, in the DC/DC converter employing the peak current mode control system, the transistor Q1 is driven and controlled in accordance with the monitored results of the output voltage Vo and the inductor current IL.

Moreover, the DC/DC converter embodying the invention has, in order to monitor the output current Io, the sensing resistor Rs in the power supply line leading to the load which is arranged in a stage after an output smoothing section (comprising L1, D1, and Co) for smoothing a voltage appearing at a terminal of the transistor Q1. The DC/DC converter is also configured, in a driver section thereof for driving and controlling the transistor Q1, such that an offset voltage according to the monitored result by the sensing resistor Rs is provided for the second monitored voltage Vd before the comparator CMP receives the voltage. To be specific, the greater the voltage Vs across the sensing resistor Rs becomes, the smaller the offset voltage (the voltage produced by the variable DC voltage source E2) provided for the second monitored voltage Vd by the gm amplifier A2 is made.

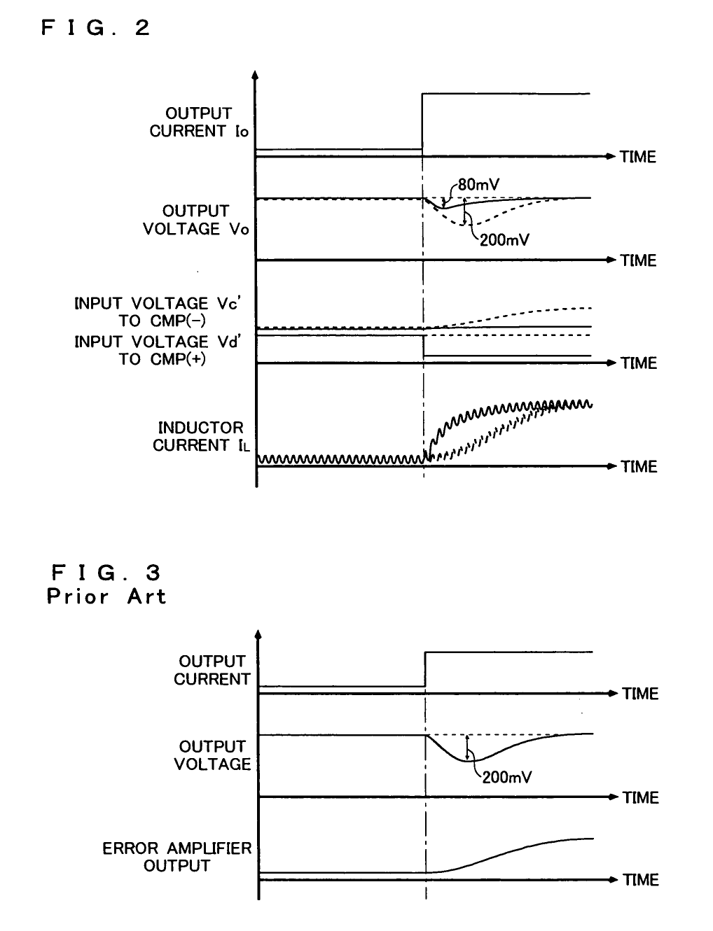

FIG. 2 is schematic diagram showing an output control operation of the DC/DC converter embodying the present invention. Shown in the illustration are behaviors of the output current Io, the output voltage Vo, the modified first monitored voltage Vc′ and the modified second monitored voltage Vd′ to be inputted to the comparator CMP, and the inductor current IL, when the load changes abruptly. It is to be noted that, in the illustration, solid lines show wave forms when the present invention is implemented and broken lines show wave forms when a conventional technology is implemented for reference purpose.

As can be read from the illustration, the DC/DC converter embodying the invention is capable of driving and controlling the transistor Q1 directly according to the result obtained by monitoring the output current Io actually flowing through the load, even if the output from the error amplifier A1 is unable to follow an abrupt change of load. Therefore, it becomes possible to start up the inductor current IL sharply and thereby efficiently suppress fluctuations of the output voltage Vo. For example, an amount of voltage drop of the output voltage Vo can be reduced from a conventional value of 200 mV to 80 mV, and a response time can be quickened from a conventional value of the order of 10 μs to the order of 1 μs. According to the DC/DC converter embodying the invention, it is also possible to avoid using a large-capacity output capacitor, and thereby prevent the cost from being unnecessarily increased and the external output capacitor from becoming large.

Particularly, when the power supply device embodying the invention is used as a means for supplying power to a data signal generating section in a liquid crystal display device comprising an LCD, it is possible to reduce a possibility of insufficient data writing to the pixel transistors, and thereby display images in superior quality with reduced problems such as a low contrast and a brightness decline.

Moreover, although the above-described embodiment deals with an example of the booster-type DC/DC converter employing the peak current mode control system, the present invention is not limited to this example and applicable also to such power supply devices in general, the power supply devices including step-down type and multi-phase type power supply devices which produce a desired output voltage from an input voltage. Although the example also shows only a Schottky diode to be used as the reverse-current preventing diode D1, it is possible to use an ordinary diode or add a switch circuit in order to eliminate the diode.

Moreover, although the above-described embodiment deals with an example having a configuration in which an offset voltage according to the monitored result by the sensing resistor Rs is provided for the second monitored voltage Vd before the comparator CMP receives the voltage in the driver section for driving and controlling the transistor Q1, the present invention is not limited to this example and applicable also to such a configuration in which the offset voltage according to the monitored result by the sensing resistor Rs is provided for the error voltage Vc before the comparator CMP receives the voltage.

As described above, a power supply device relating to the invention comprises a switching element connected between two different potentials, an output smoothing section for smoothing a voltage outputted from a terminal of the switching element and produce an output voltage provided for a load, a driver section for driving and controlling the switching element, wherein, when a desired output voltage is produced from an input voltage, an output current sensing section for monitoring current flowing through the load is provided in a stage after the output smoothing section, and the switching element is driven and controlled by the driver section by incorporating a monitored result obtained by the output current sensing section.

To be more specific, the power supply device configured as described above has the driver section comprises an error amplifier for amplifying a voltage difference between a first monitored voltage which varies according to the output voltage and a predetermined reference voltage so as to produce an error voltage, a comparator for producing a comparison signal by comparing between a second monitored voltage which varies according to a driving current flowing through the switching element and the error voltage, a driving signal generating section for generating a driving signal for driving the switching element in accordance with the comparison signal, and an offsetting section for providing an offset in accordance with a result monitored by the output current sensing section either for the second monitored voltage before the second monitored voltage is inputted to the comparator or for the error voltage before the error voltage is inputted to the comparator.

By this configuration, it is possible to provide, at a lower cost, a power supply device capable of producing a stable output voltage even if the load fluctuates abruptly.

A liquid crystal display device relating to the invention comprising a liquid crystal display and a data signal generating section for generating a data signal for the liquid crystal display has the power supply device configured as described above as a means for supplying power to the data signal generating section. According to this configuration, it is possible to reduce a possibility of insufficient data writing to pixel transistors and thereby provide a liquid crystal display device capable of displaying images in superior quality with reduced problems such as a low contrast and a brightness decline.

What is claimed is:

1. A power supply device comprising:
a switching element connected between two different potentials;
an output smoothing section for smoothing a voltage outputted from a terminal of the switching element and producing an output voltage provided for a load;
a driver section for driving and controlling the switching element; and
an output current sensing section for monitoring current flowing through the load, the output current sensing section provided in a stage after the output smoothing section,
wherein, when a desired output voltage is produced from an input voltage, the switching element is driven and controlled by the driver section by incorporating a monitored result obtained by the output current sensing section.

2. A power supply device as claimed in claim 1,
wherein the driver section includes:
an error amplifier for amplifying a voltage difference between a first monitored voltage which varies according to the output voltage and a predetermined reference voltage so as to produce an error voltage;
a comparator for producing a comparison signal by comparing between a second monitored voltage which varies according to a driving current flowing through the switching element and the error voltage;
a driving signal generating section for generating a driving signal for driving the switching element in accordance with the comparison signal; and
an offsetting section for providing an offset in accordance with a result monitored by the output current sensing section either for the second monitored voltage before the second monitored voltage is inputted to the comparator or for the error voltage before the error voltage is inputted to the comparator.

3. A power supply device as claimed in claim 2,
wherein the driving signal generating section comprises a reset-priority-type RS latch circuit having a reset terminal for receiving the comparison signal, a set terminal for receiving a clock signal, and an output terminal for outputting the driving signal.

4. A power supply device as claimed in claim 2,
wherein the output current sensing section comprises a sensing resistor.

5. A power supply device as claimed in claim 4,
wherein the offsetting section includes an amplifier for amplifying a voltage across the sensing resistor and a variable DC voltage source for providing an offset voltage in accordance with an output voltage of the amplifier for either the second monitored voltage or the error voltage.

6. A liquid crystal display device comprising:
a liquid crystal display;
a data signal generating section for generating a data signal for the liquid crystal display; and
a power supply device for supplying power to the data signal generating section, the power supply device comprising:
a switching element connected between two different potentials;
an output smoothing section for smoothing a voltage outputted from a terminal of the switching element and producing an output voltage provided for a load;
a driver section for driving and controlling the switching element; and
an output current sensing section for monitoring current flowing through the load, the output current sensing section provided in a stage after the output smoothing section,
wherein, when a desired output voltage is produced from an input voltage, the switching element is driven and controlled by the driver section by incorporating a monitored result obtained by the output current sensing section.
